(19) United States
(12) Patent Application Publication
(10) Pub. No.: US 2024/0113300 A1
(43) Pub. Date: Apr. 4, 2024

(54) MODIFIED BINDERS FOR ELECTROCHEMICAL CELLS THAT CYCLE LITHIUM IONS AND METHODS OF FORMING THE SAME

(71) Applicant: GM GLOBAL TECHNOLOGY OPERATIONS LLC, Detroit, MI (US)

(72) Inventors: Yong LU, Shanghai (CN); Meiyuan WU, Shanghai (CN); Dewen KONG, Shanghai (CN); Haijing LIU, Shanghai (CN)

(73) Assignee: GM GLOBAL TECHNOLOGY OPERATIONS LLC, Detroit, MI (US)

(21) Appl. No.: 18/070,090

(22) Filed: Nov. 28, 2022

(30) Foreign Application Priority Data
Sep. 29, 2022 (CN) 202211204915.5

(51) Int. Cl. H01M 4/62; C08L 27/18; H01M 10/0525

(52) U.S. Cl. CPC H01M 4/623; C08L 27/18; H01M 10/0525; C08L 2207/53

(57) ABSTRACT

The present disclosure provides a modified binder for use in an electrochemical cell that cycles lithium ions. The modified binder includes one or more agglomerates of polytetrafluoroethylene nanoparticles, where each of the polytetrafluoroethylene nanoparticles includes a polytetrafluoroethylene core and a polymeric shell that is disposed on exposed surfaces of the core. The polymeric shell can include a polymer selected from the group consisting of: polyethylene oxide, polyglycidyl methacrylate, polyvinylidene difluoride, fluoride-hexafluoropropylene, polypropylene oxide, polyacrylonitrile, polymethacrylonitrile, polymethyl methacrylate, derivatives and co-polymers, and combinations thereof, and in certain instances, also a humidity tolerant lithium salt. The polytetrafluoroethylene core can have a first particle size ranging from about 10 nanometers to about 500 nanometers, the polymeric shell can have an average thickness ranging from about 10 nanometers to about 1,000 nanometers, and each of the one or more agglomerates can have an average size ranging from about 100 micrometers about 1,000 micrometers.

### CROSS-REFERENCE TO RELATED APPLICATIONS

This application claims the benefit and priority of Chinese Application No. 202211204915.5, filed Sep. 29, 2022. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, the use of polytetrafluoroethylene (PTFE) as an electrode binder is often desirable because the binder holds extra active materials to permit forming thicker electrodes, while also exhibiting higher temperature (e.g., greater than or equal to about 327° C.) and chemical resistance. However, undesirable side reactions often occur between the polytetrafluoroethylene (PTFE) and certain battery materials, for example, anode materials, during the lithium ion insertion processes, especially at the initial lithium ion insertion process, resulting in reduced anodic Columbic efficiency and degradation of certain mechanical properties. Accordingly, it would be desirable to develop improved electrode materials, and methods of making and using the same, that can address these challenges.

### SUMMARY

This section provides a general summary of the disclosure, and is not a comprehensive disclosure of its full scope or all of its features.

The present disclosure relates to electrochemical cells including modified polytetrafluoroethylene (PTFE) binders and to methods of making and using the same.

In various aspects, the present disclosure provides a modified binder for use in an electrochemical cell that cycles lithium ions. The modified binder includes one or more agglomerates of polytetrafluoroethylene (PTFE) nanoparticles, where each of the polytetrafluoroethylene (PTFE) nanoparticles includes a polytetrafluoroethylene (PTFE) core and a polymeric shell that is disposed on exposed surfaces of the core.

In one aspect, the polymeric shell may include a polymer selected from the group consisting of: polyethylene oxide (PEO), polyglycidyl methacrylate (PGMA), polyvinylidene difluoride (PVdF), fluoride-hexafluoropropylene (PVDF-HFP), polypropylene oxide (PPO), polyacrylonitrile (PAN), polymethacrylonitrile (PMAN), polymethyl methacrylate (PMMA), derivatives and co-polymers, and combinations thereof.

In one aspect, the polymeric shell may further include greater than 0 wt. % to less than or equal to about 20 wt. % of a humidity tolerant lithium salt.

In one aspect, the humidity tolerant lithium salt may be selected from the group consisting of: lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), lithium trifluoromethyl sulfonate (LiTfO), and combinations thereof.

In one aspect, the polytetrafluoroethylene (PTFE) core may have a first particle size greater than or equal to about 10 nanometers to less than or equal to about 500 nanometers, the polymeric shell may have an average thickness greater than or equal to about 10 nanometers to less than or equal to about 1,000 nanometers, and each of the one or more agglomerates may have an average size greater than or equal to about 100 micrometers to less than or equal to about 1,000 micrometers.

In one aspect, the polymeric shell may be a continuous coating covering greater than or equal to about 98% of the total exposed surface area of the core.

In one aspect, the polymeric shell may be a discontinuous coating covering less than or equal to about 50% of the total exposed surface area of the core.

In various aspects, the present disclosure provides an electrochemical cell that cycles lithium ions. The electrochemical cell may include a first electrode, a second electrode, and a separating layer disposed between the first and second electrodes. The first electrode may include a positive electroactive material. The second electrode may include a negative electroactive material and a modified binder that includes one or more agglomerates of polytetrafluoroethylene (PTFE) nanoparticles. Each of the polytetrafluoroethylene (PTFE) nanoparticles may include a polytetrafluoroethylene (PTFE) core and a polymeric shell that is disposed on exposed surfaces of the core.

In one aspect, the polymeric shell may include a polymer selected from the group consisting of: polyethylene oxide (PEO), polyglycidyl methacrylate (PGMA), polyvinylidene difluoride (PVdF), fluoride-hexafluoropropylene (PVDF-HFP), polypropylene oxide (PPO), polyacrylonitrile (PAN), polymethacrylonitrile (PMAN), polymethyl methacrylate (PMMA), derivatives and co-polymers, and combinations thereof.

In one aspect, the polymeric shell may further include greater than 0 wt. % to less than or equal to about 20 wt. % of a humidity tolerant lithium salt. The humidity tolerant lithium salt may be selected from the group consisting of: lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), lithium trifluoromethyl sulfonate (LiTfO), and combinations thereof.

In one aspect, the polymeric shell may be a continuous coating covering greater than or equal to about 98% of the total exposed surface area of the binder material core.

In one aspect, the polymeric shell may be a discontinuous coating covering less than or equal to about 50% of the total exposed surface area of the binder material core.

In one aspect, the electrochemical cell may further include greater than or equal to about 0.01 wt. % to less than or equal to about 50 wt. % of an unmodified binder selected from the group consisting of: poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), polyethylene oxide (PEO), polyacrylonitrile (PAN), polyethylene(PE), polypropylene (PP), lithium polyacrylate (LiPAA), and combinations thereof.

In one aspect, the polytetrafluoroethylene (PTFE) core may have a first particle size greater than or equal to about 10 nanometers to less than or equal to about 500 nanometers, the polymeric shell may have an average thickness greater than or equal to about 10 nanometers to less than or equal to about 1,000 nanometers, and each of the one or more agglomerates may have an average size greater than or equal to about 100 micrometers to less than or equal to about 1,000 micrometers.

In one aspect, the first electrode may also include the modified binder.

In various aspects, the present disclosure provides a method for forming a modified binder for use in electrochemical cell that cycles lithium ions. The method may include contacting a plurality of polytetrafluoroethylene (PTFE) nanoparticles and a polymeric precursor, and polymerizing the polymeric precursor to form a polymeric shell on exposed surfaces of at least a portion of the polytetrafluoroethylene (PTFE) nanoparticles.

In one aspect, the polymeric precursor includes greater than or equal to about 1 wt. % to less than or equal to about 30 wt. % of a polymer, greater than or equal to about 0.01 wt. % to less than or equal to about 3.0 wt. % of an initiator, and greater than or equal to about 50 wt. % to less than or equal to about 98 wt. % of a solvent. The polymer may include monomers selected from ethylene oxide (EO), glycidyl methacrylate (GMA), vinylidene difluoride (VDF), fluoride-hexafluoropropylene (VDF-HFP), propylene oxide (PO), acrylonitrile (AN), methacrylonitrile (MAN), methyl methacrylate (MMA), corresponding oligomers and co-polymers, and combinations thereof. The initiator may be selected from the group consisting of: di(4-tert-butylcyclohexyl)peroxydicarbonate, benzoyl peroxide (BPO), azodicyandiamide (ANBI), peroxide with a reducing agent, benzophenone, 1-[4-(2-hydroxyethoxyl)-phenyl]-2-hydroxy-methyl propanol, 2-hydroxy-2-methyl-1-phenyl propanone, 2,4,6-trimethylphenol-diphenyl phosphine oxide, and combinations thereof. The solvent may be selected from the group consisting of: ethylene carbonate (EC), dimethyl carbonate (DMC), ethylmethyl carbonate (EMC), diethyl carbonate (DEC), propylene carbonate (PC), acetonitrile (CAN), methyl alcohol (MA), gamma-butyrolactone (GBL), and combinations thereof.

In one aspect, the polymeric precursor may further include greater than 0 wt. % to less than or equal to about 20 wt. % of a humidity tolerable lithium salt. The humidity tolerable lithium salt may be selected from the group consisting of: lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), lithium trifluoromethyl sulfonate (LiTfO), and combinations thereof.

In one aspect, the polymeric precursor may be a polymeric melt having a melting temperature less than or equal to about 327° C. and may include a polymer selected from the group consisting of: polyethylene oxide (PEO), polyglycidyl methacrylate (PGMA), polyvinylidene difluoride (PVdF), fluoride-hexafluoropropylene (PVDF-HFP), polypropylene oxide (PPO), polyacrylonitrile (PAN), polymethacrylonitrile (PMAN), polymethyl methacrylate (PMMA), derivatives and co-polymers, and combinations thereof. The polymerizing may include cooling the polymeric melt to greater than or equal to about 20° C. to less than or equal to about 30° C.

In one aspect, the polymeric melt may further include greater than 0 wt. % to less than or equal to about 20 wt. % of a humidity tolerable lithium salt. The humidity tolerable lithium salt may be selected from the group consisting of: lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), lithium trifluoromethyl sulfonate (LiTfO), and combinations thereof.

Corresponding reference numerals indicate corresponding parts throughout the several views of the drawings.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell including a modified polytetrafluoroethylene (PTFE) binder in accordance with various aspects of the present disclosure;

FIG. 2 is an illustration of a modified polytetrafluoroethylene (PTFE) binder in accordance with various aspects of the present disclosure;

FIG. 3 is a flowchart illustrating an example method for forming a modified polytetrafluoroethylene (PTFE) binder in accordance with various aspects of the present disclosure;

FIG. 4 is a flowchart illustrating another example method for forming a modified polytetrafluoroethylene (PTFE) binder in accordance with various aspects of the present disclosure; and

FIG. 5 is a graphical illustration demonstrating the Columbic efficiency for an example cell having an electrode that includes a modified polytetrafluoroethylene (PTFE) binder in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including modified polytetrafluoroethylene (PTFB) binders and to methods of making and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

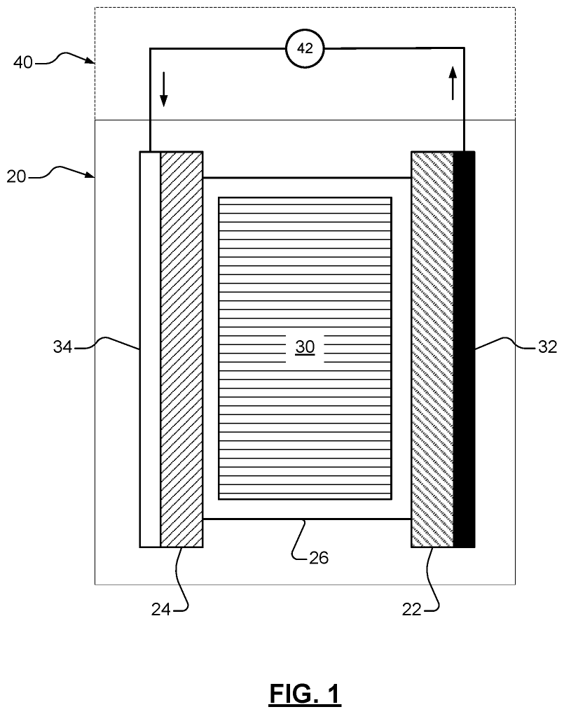

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may include a metal foil, metal grid or screen, expanded metal comprising copper, or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may include a metal foil, metal grid or screen, expanded metal comprising aluminum, or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3-x}TiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22 between the negative electroactive material particles. For example, in certain variations, the negative electrode 22 may include a plurality of solid-state electrolyte particles dispersed with the negative electroactive material particles. In each instance, the negative electrode 22 (including the one or more layers) may have an average thickness greater than or equal to about 1 μm to less than or equal to about 1,000 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like) and/or metal oxides (such as SnO₂, Fe₃O₄, and the like). In further variations, the negative electrode 22 may include a silicon-based electroactive material (such as silicon (Si), silicon oxide (SiOₓ, 0≤x≤2), and the like). In still further variations, the negative electrode 22 may be a composite electrode including a combination of negative electroactive materials. For example, the negative electrode 22 may include a first negative electroactive material and a second negative electroactive material. In certain variations, a mass ratio of the first negative electroactive material to the second negative electroactive material may be greater than or equal to about 5:95 to less than or equal to about 95:5. The first negative electroactive material may be a volume-expanding material including, for example, silicon, aluminum, germanium, and/or tin. The second negative electroactive material may include a carbonaceous material (e.g., graphite, hard carbon, and/or soft carbon) For example, in certain variations, the negative electroactive material may include a carbonaceous-silicon based composite including, for example, about 10 wt. % SiOₓ (where 0≤x≤2) and about 90 wt. % graphite. In each instance, the negative electroactive material may be prelithiated.

In various aspects, the negative electroactive material may be optionally intermingled with an electronically conductive material (i.e. conductive additive) that provide an electron conductive path. For example, the negative electrode 22 may include greater than or equal to about 0 wt. % to less than or equal to about 99.5 wt. %, and in certain aspects, optionally greater than or equal to about 60 wt. % to less than or equal to about 95 wt. %, of the negative electroactive material; and greater than or equal to 0 wt. % to less than or equal to about 30 wt. %, optionally greater than or equal to 0.1 wt. % to less than or equal to about 30 wt. %, and in certain aspects, optionally greater than or equal to about 0.5 wt. % to less than or equal to about 10 wt. %, of the electronically conducting material. Example conductive additives include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples conductive polymers include polyaniline (PANi), polythiophene, polyacetylene, polypyrrole (PPy), and the like.

In various aspects, the negative electroactive material (and optionally the electronically conductive material) may be intermingled with a modified polytetrafluoroethylene (PTFE) binder. For example, the negative electrode 22 may include greater than or equal to about 0 wt. % to less than or equal to about 20 wt. %, optionally greater than or equal to about 0.01 wt. % to less than or equal to about 10 wt. %, and in certain aspects, optionally greater than or equal to about 0.01 wt. % to less than or equal to about 5 wt. %, of the modified polytetrafluoroethylene (PTFE) binder. After fabrication, the modified polytetrafluoroethylene (PTFE) binder may form fibrils that bind together the electrode materials (i.e., negative electroactive material and optional the electronically conductive material) of the negative electrode 22.

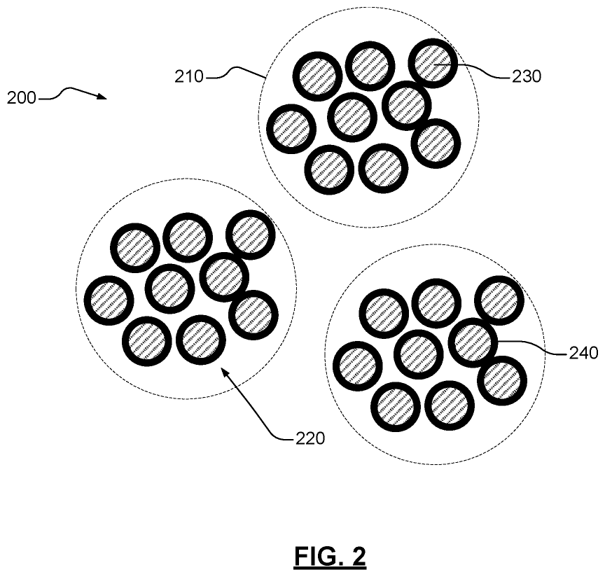

In each instance, as illustrated in FIG. 2, the modified polytetrafluoroethylene (PTFE) binder 200 includes one or more agglomerates (or clusters) 210 of surface-modified polytetrafluoroethylene (PTFE) nanoparticles 220, each of the surface-modified polytetrafluoroethylene (PTFE) nanoparticles 220 includes, for example, a polytetrafluoroethylene (PTFE)-containing nanosized core 230 and a polymeric shell 240 disposed on exposed surfaces of the nanosized core 230. As illustrated, the polymeric shell 240 may be a substantially continuous layer that covers, for example, greater than or equal to about 50%, optionally greater than or equal to about 80%, optionally greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.5%, of a total exposed surface of the polytetrafluoroethylene (PTFE)-containing nanosized core 230. Although not illustrated, it should be appreciated that in certain variations, the polymeric shell 220 may be a discontinuous layer covering, for example, greater than or equal to about 0.1% to less than or equal to about 50%, and in certain aspects, greater than or equal to about 20% to less than or equal to about 40%, of a total exposed surface of the polytetrafluoroethylene (PTFE)-containing nanosized core 230.

In each variation, the polymeric shell 240 may have an average thickness greater than or equal to about 10 nanometers (nm) to less than or equal to about 1,000 nm, and in certain aspects, optionally greater than or equal to about 50 nm to less than or equal to about 300 nm, and may include a polyethylene oxide (PEO), polyglycidyl methacrylate (PGMA), polyvinylidene difluoride (PVdF), fluoride-hexafluoropropylene (PVDF-HFP), polypropylene oxide (PPO), polyacrylonitrile (PAN), polymethacrylonitrile (PMAN), polymethyl methacrylate (PMMA), derivatives (e.g., corresponding functional group-modified polymers), and/or co-polymers. In certain variations, the polymeric shell 220 may also include a humidity tolerant lithium salt, such as lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), and/or lithium trifluoromethyl sulfonate (LiTfO). For example, the polymeric shell 220 may include greater than or equal to about 0 wt. % to less than or equal to about 20 wt. %, and in certain aspects, optionally greater than or equal to about 0.1 wt. % to less than or equal to about 20 wt. %, of the humidity tolerant lithium salt.

The polytetrafluoroethylene (PTFE)-containing nanosized core 230 may have an average particle size that is greater than or equal to about 10 nanometers (nm) to less than or equal to about 500 nm, and in certain aspects, optionally greater than or equal to about 50 nm to less than or equal to about 300 nm, and the agglomerate 220 may have a second average particle size that is greater than or equal to about 100 Inn to less than or equal to about 1,000 Inn, and in certain aspects, optionally greater than or equal to 300 Inn to less than or equal to about 700 In certain variations, the one or more agglomerates 220 may be referred to as secondary polytetrafluoroethylene (PTFE) particles, and the surface-modified polytetrafluoroethylene (PTFE) nanoparticles 220 may be referred to as primary polytetrafluoroethylene (PTFE) particles.

With renewed reference to FIG. 1, in certain variations, the negative electrode 22 may include a combination of binder materials. For example, the negative electrode 22 may include greater than or equal to about 50 wt. % to less than or equal to about 99.9 wt. %, and in certain aspects, optionally greater than or equal to about 70 wt. % to less than or equal to about 95 wt. %, of the modified binder, and greater than or equal to about 0.01 wt. % to less than or equal to about 50 wt. %, and in certain aspects, optionally greater than or equal to about 5 wt. % to less than or equal to about 30 wt. %, of another or unmodified binder. The unmodified binder may include, for example, polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), styrene ethylene butylene styrene copolymer (SEBS), styrene butadiene styrene copolymer (SBS), polyethylene oxide (PEO), polyethylene (PE), polypropylene (PP), sodium alginate, and/or lithium alginate.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 1,000 μm, and in certain aspects, optionally greater than or equal to about 10 μm to less than or equal to about 200 μm.

In various aspects, the positive electroactive material includes a high-voltage oxides, such as LiNi_{0.5}Mn_{1.5}O₄. In other variations, the positive electroactive mate includes a layered oxide represented by LiMeO₂, where Me is a transition metal, such as cobalt (Co), nickel (Ni), manganese (Mn), iron (Fe), aluminum (Al), vanadium (V), or combinations thereof. For example, in certain variations, the positive electroactive material may include LiNiₓMn_{y}CO_{1-x-y}O₂ (where 0<x<1 and 0<y<1), LiNiₓCO_{y}Al_{1-x-y}O₂ (where 0<x<1 and 0<y<1), LiNiₓMn₁₋ₓO₂ (where 0<x<1), and/or Li₁₊ₓMO₂ (where 0<x<1). In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a favorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations, the positive electroactive material includes a combination of positive electroactive materials. For example, the positive electrode 24 may include one or more high-voltage oxides, one or more layered oxides, one or more olivine-type oxides, one or more monoclinic-type oxides, one or more spinel-type oxide, one or more favorite, or combinations thereof. In each instance, the positive electroactive material may be surface coated and/or doped (e.g., LiNbO₃— coated LiNi_{0.5}Mn_{1.5}O₄).

In each variation, the positive electroactive material may be optionally intermingled with an electronically conductive material (i.e. conductive additive) that provide an electron conductive path and/or a polymeric binder material that improve the structural integrity of the positive electrode 24. For example, the positive electrode 24 may include greater than or equal to about 0 wt. % to less than or equal to about 99.5 wt. %, and in certain aspects, optionally greater than or equal to about 60 wt. % to less than or equal to about 95 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than or equal to about 0.01 wt. % to less than or equal to about 20 wt. %, and in certain aspects, optionally greater than or equal to about 0.01 wt. % to less than or equal to about 5 wt. %, of the polymeric binder. The conductive additive and/or binder material as included in the positive electrode 24 may be the same as or different from the conductive additive and/or binder material as included in the negative electrode 22.

In various aspects, the present disclosure provides methods for forming modified polytetrafluoroethylene (PTFE) binders like the modified polytetrafluoroethylene (PTFE) binder 200 illustrated in FIG. 2. In certain variations, the modified polytetrafluoroethylene (PTFE) binders may be prepared using in-situ polymerization processes, and in other variations, the polytetrafluoroethylene (PTFE) modified binders may be prepared using melting immersion processes. In each instance, the modified polytetrafluoroethylene (PTFE) binders are prepared using non-destructive (e.g., no or low friction) methods such that shells are formed on primary particles without early fibrillation of secondary particles.

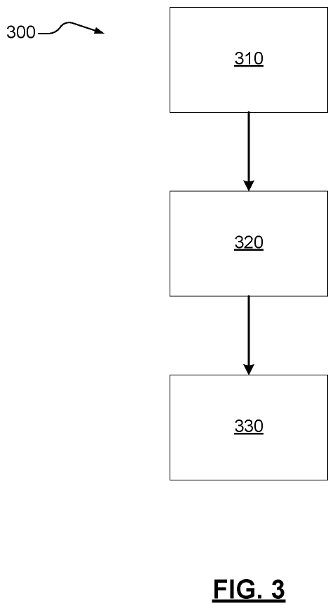

As illustrated in FIG. 3, an example method 300 for forming a modified polytetrafluoroethylene (PTFE) binder may include contacting 320 a polytetrafluoroethylene (PTFE) binder precursor including agglomerates of nanosized particles with a precursor solution and maintaining the contact such that a composite is formed using a process that is substantially free of friction between the secondary particles, such as self-diffusion. The precursor solution includes a polymer, an initiator, and a solvent. For example, the precursor solution may include greater than or equal to about 1 wt. % to less than or equal to about 30 wt. %, and in certain aspects, optionally greater than or equal to about 3 wt. % to less than or equal to about 20 wt. %, of the polymer; greater than or equal to about 0.01 wt. % to less than or equal to about 3.0 wt. %, and in certain aspects, optionally greater than or equal to about 0.1 wt. % to less than or equal to about 0.5 wt. %, of the initiator; and greater than or equal to about 50 wt. % to less than or equal to about 98 wt. %, and in certain aspects, greater than or equal to about 80 wt. % to less than or equal to about 95 wt. %, of the solvent. In certain variations, the method 300 may include preparing 310 the precursor solution by contacting (e.g., mixing together) the polymer, initiator, and solvent.

The polymer may include monomers selected from ethylene oxide (EO), glycidyl methacrylate (GMA), vinylidene difluoride (VDF), fluoride-hexafluoropropylene (VDF-HFP), propylene oxide (PO), acrylonitrile (AN), methacrylonitrile (MAN), methyl methacrylate (MMA), and/or their corresponding oligomers and co-polymers. In the instance of heat-based polymerization, the initiator may include a peroxide (e.g., di(4-tert-butylcyclohexyl)peroxydicarbonate, benzoyl peroxide (BPO)), an azo compound (azodicyandiamide (ANBI), and/or a peroxide with a reducing agent (e.g., low-valence metal salt, such as S₂O₄²⁻+Fe²⁺, Cr³⁺, Cu⁺). In the instance of UV-based polymerization, the initiator may include benzophenone, 1-[4-(2-hydroxyethoxyl)-phenyl]-2-hydroxy-methyl propanol, 2-hydroxy-2-methyl-1-phenyl propanone, 2,4,6-trimethylphenol-diphenyl phosphine oxide. The solvent may include, for example, ethylene carbonate (EC), dimethyl carbonate (DMC), ethylmethyl carbonate (EMC), diethyl carbonate (DEC), propylene carbonate (PC), acetonitrile (CAN), methyl alcohol (MA), and/or gamma-butyrolactone (GBL).

In certain variations, the precursor solution may also include a humidity tolerable lithium salt, such as lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), and/or lithium trifluoromethyl sulfonate (LiTfO). The precursor solution may include greater than or equal to about 0 wt. % to less than or equal to about 20 wt. %, and in certain aspects, optionally greater than or equal to about 1 wt. % to less than or equal to about 10 wt. %, of the lithium salt.

In each variation, the method 300 may further include polymerizing 330 the polymers on or near a surface of the nanosized particles to form polymeric shells. The polymerization may be initiated using heat and/or ultraviolet. Although not illustrated, it should be appreciated that in certain variations, the method 300 may include contacting the as formed binder with other electrode materials (i.e., (i.e., negative electroactive material and optional the electronically conductive material) to form the electrode and/or combining the electrode with other electrodes to form an electrochemical device.

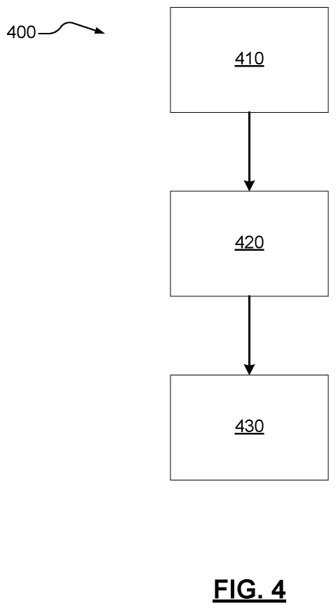

As illustrated in FIG. 4, an example method 400 for forming a modified polytetrafluoroethylene (PTFE) binder may include contacting 420 a polytetrafluoroethylene (PTFE) binder precursor including agglomerates of nanosized particles with a polymer melt including, for example, at least one of polyethylene oxide (PEO), polyglycidyl methacrylate (PGMA), polyvinylidene difluoride (PVdF), fluoride-hexafluoropropylene (PVDF-HFP), polypropylene oxide (PPO), polyacrylonitrile (PAN), polymethacrylonitrile (PMAN), polymethyl methacrylate (PMMA), derivatives (e.g., corresponding functional group-modified polymers), and/or co-polymers. The polymer melt must have a temperature that is less than the melting point of the polytetrafluoroethylene (PTFE) binder precursor (e.g., 327° C.). In certain variations, the polymer melt may also include a humidity tolerable lithium salt, such as lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), and/or lithium trifluoromethyl sulfonate (LiTfO). The polymer melt may include greater than or equal to about 0 wt. % to less than or equal to about 20 wt. %, and in certain aspects, optionally greater than or equal to about 0.1 wt. % to less than or equal to about 20 wt. %, of the humidity tolerable lithium salt. The contact between the polymer melt and the polytetrafluoroethylene (PTFE) binder precursor must be maintained such that a composite is formed via a process that is substantially free of friction between the secondary particles, such as self-diffusion. In certain variations, the method 400 may include preparing 410 the polymer melt by heating the polymers, and optionally the humidity tolerable lithium salts, to a melting point.

In each variation, the method 400 may further include polymerizing 430 the polymers on or near surfaces of the nanosized particles to form polymeric shells. The polymerization may be initiated by cooling the composite to room temperature (i.e., greater than or equal to about 20° C. to less than or equal to about 30° C.). Although not illustrated, it should be appreciated that in certain variations, the method 400 may include contacting the as formed binder with other electrode materials (i.e., (i.e., negative electroactive material and optional the electronically conductive material) to form the electrode and/or combining the electrode with other electrodes to form an electrochemical device.

Certain features of the current technology are further illustrated in the following non-limiting examples.

### Example 1

Example batteries and battery cells may be prepared in accordance with various aspects of the present disclosure.

For example, an example cell 510 includes an electrode that includes a modified polytetrafluoroethylene (PTFE) binder prepared in accordance with various aspects of the present disclosure dispersed with a negative electroactive material (e.g., graphite). For example, the polytetrafluoroethylene (PTFE) binder may include agglomerates of nanosized particles that are coated with ethylene oxide (EO) and/or glycidyl methacrylate (PGMA) and/or humidity tolerable lithium salts (e.g., lithium bis(trifluoromethanesulfonyl)imide (LiTFSI) and lithium tetrafluoroborate (LiBF₄), in a molar ratio of 1:1). A comparative cell 520 may have a similar configuration as the example cell 510. However, the comparative cell 520 includes an unmodified polytetrafluoroethylene (PTFE).

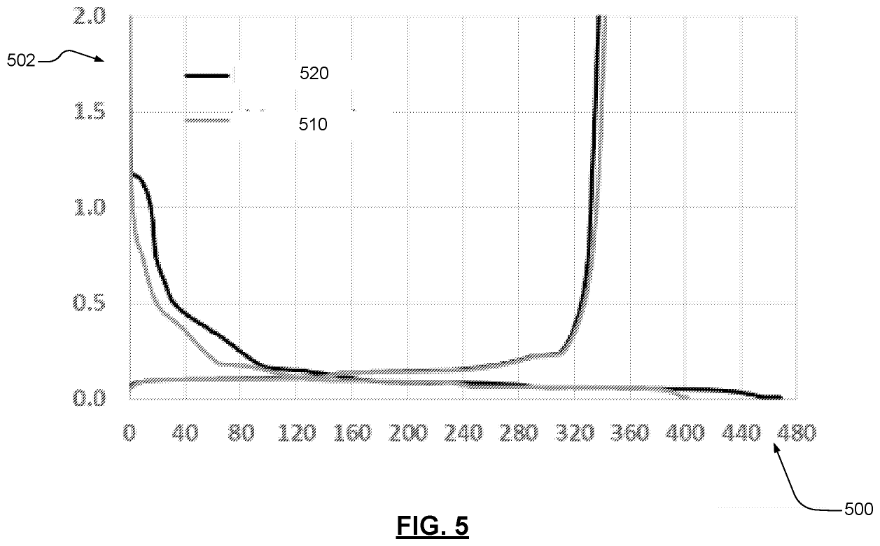

FIG. 5 is a graphical illustrating demonstrating the Columbic efficiency of the example cell 510 as compared to the comparative cell 520, where the x-axis 500 represents capacity (mAh·g⁻¹), and the y-axis 502 represents voltage (V). As illustrated, the example cell 510 has suppressed side reactions and an improved Columbic efficiency. For example, the example cell 510 may have a Columbic efficiency of about 85.2%, while the comparative cell 520 has a Columbic efficiency of only about 69.5%.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A modified binder for use in an electrochemical cell that cycles lithium ions, the modified binder comprising:
one or more agglomerates of polytetrafluoroethylene (PTFE) nanoparticles, each of the polytetrafluoroethylene (PTFE) nanoparticles comprising a polytetrafluoroethylene (PTFE) core and a polymeric shell disposed on exposed surfaces of the core.

2. The modified binder of claim 1, wherein the polymeric shell comprises a polymer selected from the group consisting of: polyethylene oxide (PEO), polyglycidyl methacrylate (PGMA), polyvinylidene difluoride (PVdF), fluoride-hexafluoropropylene (PVDF-HFP), polypropylene oxide (PPO), polyacrylonitrile (PAN), polymethacrylonitrile (PMAN), polymethyl methacrylate (PMMA), derivatives and co-polymers, and combinations thereof.

3. The modified binder of claim 2, wherein the polymeric shell further comprises greater than 0 wt. % to less than or equal to about 20 wt. % of a humidity tolerant lithium salt.

4. The modified binder of claim 3, wherein the humidity tolerant lithium salt is selected from the group consisting of: lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), lithium trifluoromethyl sulfonate (LiTfO), and combinations thereof.

5. The modified binder of claim 1, wherein the polytetrafluoroethylene (PTFE) core has a first particle size greater than or equal to about 10 nanometers to less than or equal to about 500 nanometers, the polymeric shell has an average thickness greater than or equal to about 10 nanometers to less than or equal to about 1,000 nanometers, and each of the one or more agglomerates having an average size greater than or equal to about 100 micrometers to less than or equal to about 1,000 micrometers.

6. The modified binder of claim 1, wherein the polymeric shell is a continuous coating covering greater than or equal to about 98% of the total exposed surface area of the core.

7. The modified binder of claim 1, wherein the polymeric shell is a discontinuous coating covering less than or equal to about 50% of the total exposed surface area of the core.

8. An electrochemical cell that cycles lithium ions, the electrochemical cell comprising:
a first electrode comprising a positive electroactive material;
a second electrode comprising a negative electroactive material and a modified binder comprising one or more agglomerates of polytetrafluoroethylene (PTFE) nanoparticles, each of the polytetrafluoroethylene (PTFE) nanoparticles comprising a polytetrafluoroethylene (PTFE) core and a polymeric shell disposed on exposed surfaces of the core; and
a separating layer disposed between the first and second electrodes.

9. The electrochemical cell of claim 8, wherein the polymeric shell comprises a polymer selected from the group consisting of: polyethylene oxide (PEO), polyglycidyl methacrylate (PGMA), polyvinylidene difluoride (PVdF), fluoride-hexafluoropropylene (PVDF-HFP), polypropylene oxide (PPO), polyacrylonitrile (PAN), polymethacrylonitrile (PMAN), polymethyl methacrylate (PMMA), derivatives and co-polymers, and combinations thereof.

10. The electrochemical cell of claim 8, wherein the polymeric shell further comprises greater than 0 wt. % to less than or equal to about 20 wt. % of a humidity tolerant lithium salt selected from the group consisting of: lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), lithium trifluoromethyl sulfonate (LiTfO), and combinations thereof.

11. The electrochemical cell of claim 8, wherein the polymeric shell is a continuous coating covering greater than or equal to about 98% of the total exposed surface area of the binder material core.

12. The electrochemical cell of claim 8, wherein the polymeric shell is a discontinuous coating covering less than or equal to about 50% of the total exposed surface area of the binder material core.

13. The electrochemical cell of claim 8, further comprising greater than or equal to about 0.01 wt. % to less than or equal to about 50 wt. % of an unmodified binder selecting from the group consisting of: poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), polyethylene oxide (PEO), polyacrylonitrile (PAN), polyethylene(PE), polypropylene (PP), lithium polyacrylate (LiPAA), and combinations thereof.

14. The electrochemical cell of claim 8, wherein the polytetrafluoroethylene (PTFE) core has a first particle size greater than or equal to about 10 nanometers to less than or equal to about 500 nanometers, the polymeric shell has an average thickness greater than or equal to about 10 nanometers to less than or equal to about 1,000 nanometers, and each of the one or more agglomerates having an average size greater than or equal to about 100 micrometers to less than or equal to about 1,000 micrometers.

15. The electrochemical cell of claim 8, wherein the first electrode also comprises the modified binder.

16. A method for forming a modified binder for use in electrochemical cell that cycles lithium ions, the method comprising:
contacting a plurality of polytetrafluoroethylene (PTFE) nanoparticles and a polymeric precursor; and
polymerizing the polymeric precursor to form a polymeric shell on exposed surfaces of at least a portion of the polytetrafluoroethylene (PTFE) nanoparticles.

17. The method of claim 16, wherein the polymeric precursor comprises:
greater than or equal to about 1 wt. % to less than or equal to about 30 wt. % of a polymer comprising monomers selected from ethylene oxide (EO), glycidyl methacrylate (GMA), vinylidene difluoride (VDF), fluoride-hexafluoropropylene (VDF-HFP), propylene oxide (PO), acrylonitrile (AN), methacrylonitrile (MAN), methyl methacrylate (MMA), corresponding oligomers and co-polymers, and combinations thereof;
greater than or equal to about 0.01 wt. % to less than or equal to about 3.0 wt. % of an initiator selected from the group consisting of: di(4-tert-butylcyclohexyl)peroxydicarbonate, benzoyl peroxide (BPO), azodicyandiamide (ANBI), peroxide with a reducing agent, benzophenone, 1-[4-(2-hydroxyethoxyl)-phenyl]-2-hydroxy-methyl propanol, 2-hydroxy-2-methyl-1-phenyl propanone, 2,4,6-trimethylphenol-diphenyl phosphine oxide, and combinations thereof; and
greater than or equal to about 50 wt. % to less than or equal to about 98 wt. % of a solvent selected from the group consisting of: ethylene carbonate (EC), dimethyl carbonate (DMC), ethylmethyl carbonate (EMC), diethyl carbonate (DEC), propylene carbonate (PC), acetonitrile (CAN), methyl alcohol (MA), gamma-butyrolactone (GBL), and combinations thereof.

18. The method of claim 17, wherein the polymeric precursor further comprises greater than 0 wt. % to less than or equal to about 20 wt. % of a humidity tolerable lithium salt selected from the group consisting of: lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), lithium trifluoromethyl sulfonate (LiTfO), and combinations thereof.

19. The method of claim 16, wherein the polymeric precursor is a polymeric melt having a melting temperature less than or equal to about 327° C. and comprising a polymer selected from the group consisting of: polyethylene oxide (PEO), polyglycidyl methacrylate (PGMA), polyvinylidene difluoride (PVdF), fluoride-hexafluoropropylene (PVDF-HFP), polypropylene oxide (PPO), polyacrylonitrile (PAN), polymethacrylonitrile (PMAN), polymethyl methacrylate (PMMA), derivatives and co-polymers, and combinations thereof, the polymerizing comprising cooling the polymeric melt to greater than or equal to about 20° C. to less than or equal to about 30° C.

20. The method of claim 19, wherein the polymeric melt further comprises greater than 0 wt. % to less than or equal to about 20 wt. % of a humidity tolerable lithium salt selected from the group consisting of: lithium bis(trifluoromethanesulfonyl)imide (LiTFSI), lithium bis(fluorosulfonyl)imide (LiN(FSO₂)₂) (LiFSI), lithium bis(oxalato)borate (LiB(C₂O₄)₂) (LiBOB), lithium tetrafluoroborate (LiBF₄), lithium hexafluoroarsenate (LiAsF₆), lithium perchlorate (LiClO₄), lithium bis(pentafluoroethanesulfonyl)imide (LiBETI), lithium difluoro(oxalato)borate (LiDFOB), lithium trifluoromethyl sulfonate (LiTfO), and combinations thereof.
